(19) United States
(12) Patent Application Publication
(10) Pub. No.: US 2013/0253902 A1
(43) Pub. Date: Sep. 26, 2013

(54) METHOD FOR THE AUTOMATED TRANSLATION OF INFORMATION

(71) Applicant: Vitaly Evgenievich Pilkin, Moscow (RU)

(72) Inventor: Vitaly Evgenievich Pilkin, Moscow (RU)

(21) Appl. No.: 13/885,787

(22) PCT Filed: Nov. 24, 2011
(86) PCT No.: PCT/RU2011/000921

§ 371 Date: May 16, 2013

(30) Foreign Application Priority Data
Dec. 17, 2010 (RU) 2010151821

(51) Int. Cl. G06F 17/28

(52) U.S. Cl. CPC G06F 17/28
USPC 704/2

(57) ABSTRACT

A method for automated translation of information comprising the use of an intermediate language when automated translation of information from one natural language (“Language 1”) into another natural language (“Language 2”) is implemented, wherein the intermediate language is one artificial language or more than one artificial languages or a combination of an artificial language and one natural language or more than one natural languages, herewith initially automated translation of information from the Language 1 into the said intermediate language is implemented and then automated translation of information from the said intermediate language into the Language 2 is implemented, herewith an artificial language includes or consists of: a) programming language, or b) computer software program, or c) programming language and computer software program.

### CROSS-REFERENCE TO RELATED APPLICATIONS

This application is a U.S. national stage application of a PCT application PCT/RU2011/000921 filed on 24 Nov. 2011, published as WO 2012/082015, whose disclosure is incorporated herein in its entirety by reference, which PCT application claims priority of a Russian Federation application RU2010151821 filed on 17 Dec. 2010.

### FIELD OF THE INVENTION

The invention relates to the electronic engineering and can be used for the improvement of quality of automated translation from one natural language into another natural language by using an intermediate language.

### BACKGROUND OF THE INVENTION

It is known Machine Translation as the technology of coherent translation of texts from one natural language into another by a computer program. Programs developed on the basis of the machine translation technology do coherent translation of a text using certain linguistic algorithms. Initially the system analyses structural elements of the sentence to be translated, then transforms it in accordance with the language structure and synthesizes a final version. Besides, for the purposes of the improvement of translation quality such program shall be able to discern set expressions and shall have wide vocabulary. Translating of texts concerning a particular subject requires the use of special dictionaries. With the help of Machine Translation systems one may receive a rough translation version immediately to catch general ideas of the text.

Translation Memory is the translation technology based on the comparing the document to be translated with the data kept in translation data base which has been preliminarily formed. When the system of translation finds a segment corresponding to the preliminarily set criteria, translation variant is taken from the Translation Memory data base. The said principle is the most efficient in connection with translation of repeated texts with similar subjects and structure.

It is known multilingual machine translation system using English as a pivot language (see page 50, paragraph “A new interpretation of a pivot language”, Interactive Japanese-European text generation—an approach to multilingual export translation based on Systemic Functional Grammar, 1993, Graham Wilcock). An intermediate natural language (English mostly) is used in connection with the automated translation from one natural language into another natural language under the said technical solution. As for the automated translation, initially a text in natural language 1 is automatically translated into the said intermediate language with further automated translation from the intermediate language into the natural language 2.

The disadvantage of the said technical solution is that for various reasons none of the most widespread natural languages of the world may be an optimal intermediate language for the said purposes due to grammatical, stylistic, semantic, cultural, historical and other specific features of natural languages. In addition, the most widespread natural languages (for example, English) do not always have large translation correspondence base in respect of rare natural languages. For example, the English language cannot be an optimal intermediate language in case of translation from Kiswahili into the Gipsy language, as there is no large base of translation correspondences between the English and Gipsy languages.

It is known a system for multilingual machine translation from English to Hindi and other Indian languages using pseudo-interlingua and hybridized approach (see the US patent application US2004/0040095, paragraph 0019-0024), wherein as an intermediate language the pseudo-interlingua approach is used, providing for the use of common properties that are typical for a language from which are translated, and for a language into which are translated. Technical solution described in US2004/0040095 is the most similar technical solution (a prototype). The disadvantage of the said technical solution is the pseudo-interlingua approach used in the said decision is not designed to be as intermediate language between languages other than English, Hindi and other Indian languages.

### DESCRIPTION OF THE INVENTION

The following terms and definitions are used for the purposes of correct understanding the terms used in connection with the present invention.

Natural Language means a language used for the purposes of intercourse between humans (other than artificially created language). Any known spoken language (for example, English, Russian, Chinese etc.) is classified as natural language.

Artificial Language means a special language which, unlike natural language, is created for a certain purposes. For example, programming language is classified as artificial language. Artificial language may exist as computer software program.

Programming Language means a formal system of symbols designed for the computer software programs recording.

Automated Translation of Information means the computer technology of translation of information with the help of machine translation, Translation Memory technology and other well-known computer methods and technologies of automated translation of information.

Translation of Information means the translation of initial information from one natural language into another.

The technical result of the claimed invention is the improvement of quality of automated translation of information from one natural language into another natural language by using an intermediate language which is other than natural language.

The said technical result is achieved as follows:

An intermediate language, being one or more than one artificial languages or a combination of an artificial language and one or more than one natural languages, is used when automated translation of information from one natural language (“Language 1”) into another natural language (“Language 2”) is implemented.

When automated translation of information is implemented initially automated translation of information from the Language 1 into the said intermediate language is implemented and then automated translation of information from the said intermediate language into the Language 2 is implemented.

An artificial language includes or consists of: a) programming language, or b) computer software program, or c) programming language and computer software program.

### EMBODIMENT OF THE INVENTION

The claimed method for automated translation of information from one natural language into another natural language is realized via the use of technical solutions and hardware known from the prior art.

### APPLICATION OF THE INVENTION

Better quality of automated translation of information from one natural language into another natural language in comparison with other known methods for automated translation of information is achieved as a result of application of the claimed invention.

1. A method for automated translation of information comprising the use of an artificial language as an intermediate language when automated translation of information from one natural language (“Language 1”) into another natural language (“Language 2”) is implemented, wherein an artificial language includes or consists of: a) programming language, or b) computer software program, or c) programming language and computer software program, herewith initially automated translation of information from the Language 1 into the said artificial language is implemented and then automated translation of information from the said artificial language into the Language 2 is implemented.

2. (canceled)
